(19) United States
(12) Patent Application Publication
(10) Pub. No.: US 2007/0166094 A1
(43) Pub. Date: Jul. 19, 2007

(54) Cosmetic unit

(75) Inventor: Norbert Dumler, Ansbach (DE)

Correspondence Address: BROWDY AND NEIMARK, P.L.L.C.;624 NINTH STREET, NW, SUITE 300, WASHINGTON, DC, 20001-5303, US

(73) Assignee: Geka Brush GmbH, Bechhofen-Waizendorf (DE)

(21) Appl. No.: 11/636,532

(22) Filed: Dec. 11, 2006

(30) Foreign Application Priority Data
Jan. 18, 2006 (EP) 06 000 974.3

(51) Int. Cl. B05C 1/00; A47L 13/12

(52) U.S. Cl. 401/17; 401/16

(57) ABSTRACT

In a cosmetic unit comprising two applicators, each having a stem, each of the applicators dipping into a respective reservoir, each reservoir having a reservoir neck provided with an external thread on which to screw a respective coupling part, and the two reservoirs being releasably attachable to each other by means of the screwed-on coupling parts, which at the same time serve as a closing cap, via a coupling sleeve by means of a snap-type connection, provision is made for the snap-type connection to comprise a locking bead disposed on the inside of the coupling sleeve in the outer end region of the coupling sleeve.

### BACKGROUND OF THE INVENTION

1. Field of the Invention

The invention relates to a cosmetic unit comprising two applicators, each having a stem, each of the applicators dipping into a respective reservoir, each reservoir having a reservoir neck provided with an external thread on which to screw a respective coupling part, and the two reservoirs being releasably attachable to each other by means of the screwed-on coupling parts, which at the same time serve as a closing cap, via a coupling sleeve by means of a snap-type connection.

2. Background Art

A cosmetic unit of this type is known from DE 102 13 643 A1. The known cosmetic unit has proven very successful in practice. It makes it possible to make two different applicators and/or cosmetic products available for application in one and the same unit. On one hand, the central coupling sleeve serves to connect the two reservoirs for the cosmetic products. On the other hand it forms a decorative surface, which significantly adds to the appearance of the unit as a whole.

Comparable cosmetic units are also known from DE 100 39 490 A1, DE 197 33 290 A1, U.S. Pat. No. 5,509,742 B1, GB 123 639 A1, and U.S. Pat. No. 3,690,777.

### SUMMARY OF THE INVENTION

In units of this type, the problem arises that in the region where the wall of the coupling sleeve, which is injection-molded from plastic, has a greater thickness, outwardly obvious surface wavinesses are visible due to the injection molding process, which are perceived as esthetically disturbing.

With this as the starting point, the invention is based on the object of improving the outer appearance of a known cosmetic unit of this type while preserving its advantages with respect to its production and handling.

This object is met according to the invention in such a way that the snap-type connection comprises a locking bead on the inside of the coupling sleeve, said locking bead being arranged in the outer end region of the coupling sleeve.

A cosmetic unit of this type allows cosmetic products to be filled by conventional machines and also provides the consumer with the option to use the two units individually, or to combine them to her personal liking at the time of purchase to suit her personal desires and needs.

Moreover, however, according to the invention, this surprisingly results in the particularly obvious central region of the coupling sleeve being completely free of surface wavinesses on the outside, with the provision of the locking beads in the frontal edge region greatly reducing the occurrence of surface wavinesses in that region, or at least rendering them visually far less prominent.

Provision is advantageously made for the locking bead to be disposed less than 5 mm from the respective front end of the coupling sleeve.

In a preferred embodiment, the locking bead in the engaged condition may overlap the respective front end of the coupling sleeve and correspondingly snap in there, so that a separate locking groove to correspond with the locking bead is not required.

In another embodiment, the locking bead cooperates with a corresponding locking groove of the respective coupling part.

In this embodiment the locking bead may have an end region that is beveled in the insertion and snap-in direction to facilitate the insertion and snap-in process, whereas against the insertion direction, a section may be provided that extends by approximately 90° against the longitudinal axis of the coupling sleeve to increase the locking strength in the engaged condition.

The invention will be explained in more detail below based on a preferred embodiment in conjunction with the drawing.

### BRIEF DESCRIPTION OF THE DRAWING

FIG. 1 shows a first example embodiment of an inventive cosmetic unit in a section,

FIG. 2 shows the detail II in FIG. 1,

FIG. 3 shows the detail III in FIG. 2,

FIG. 4 shows a section through a second embodiment of an inventive cosmetic unit with attached reservoirs,

FIG. 5 shows a view corresponding to FIG. 4, without reservoirs,

FIG. 6 shows an enlarged sectional view of the coupling sleeve, and

FIG. 7 shows the detail VII in FIG. 4.

### DESCRIPTION OF THE PREFERRED EMBODIMENT

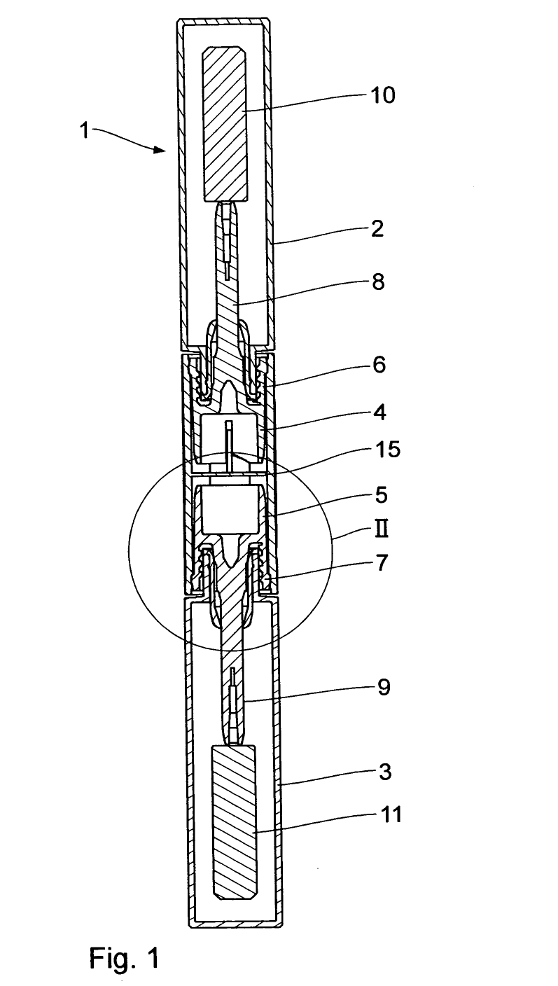

A cosmetic unit 1 shown in the drawing comprises two reservoirs 2, 3, each for a cosmetic product, for example mascara, also two coupling parts 4, 5, each coupling part having a cup-like section 6, 7, and extending away from the cup bottom, a stem 8, 9 provided at its respective distal end with an applicator 10, 11. Since the coupling parts 4, 5 are designed identical, only the region shown as the lower region in FIG. 1, marked with II, will be described in more detail below.

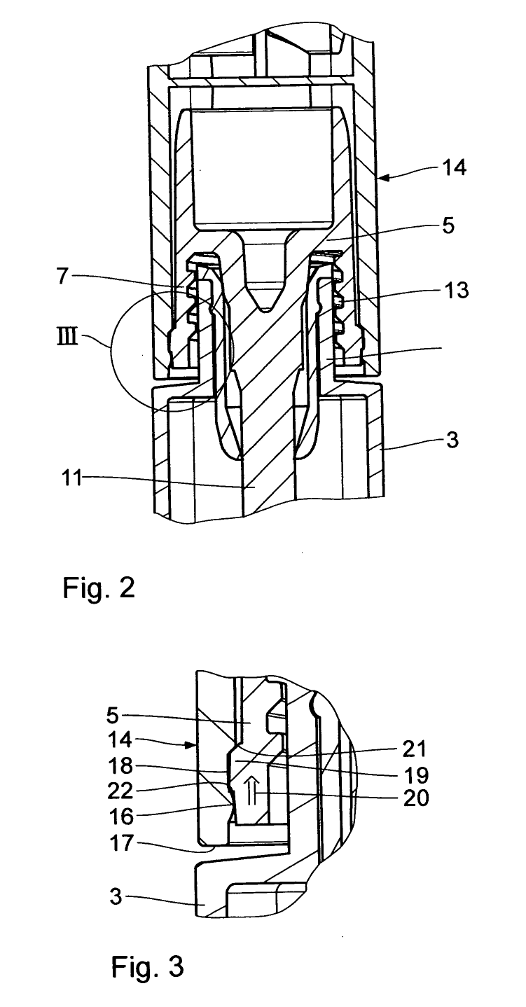

From FIG. 2 it can be seen that the reservoir 3 has a reservoir neck 12 provided with an external thread 13. The coupling part 5 has at its cup-like section 7 an inside thread that corresponds with the thread 13, so that the coupling part 5 at the same time serves as a closing means for the reservoir 3.

The coupling part 5 engages into a coupling sleeve 14, which has a transversely extending dividing bottom 15 and which is constructed mirror-symmetrical relative to the same.

FIG. 3 illustrates that the coupling sleeve 14 has a “protruding” locking bead 16. Adjoining the same in the direction away from the front end 17 of the coupling sleeve 14 is a locking groove 18, into which a circumferential locking bead 19 of the coupling part can be snapped in. The locking bead 19 has a beveled region 21 located in front in the locking direction (arrow 20), and at the rear, in the locking direction, a region 22 extending substantially perpendicular to the longitudinal axis of the coupling sleeve 14. This facilitates the snap-in process and increases the locking strength.

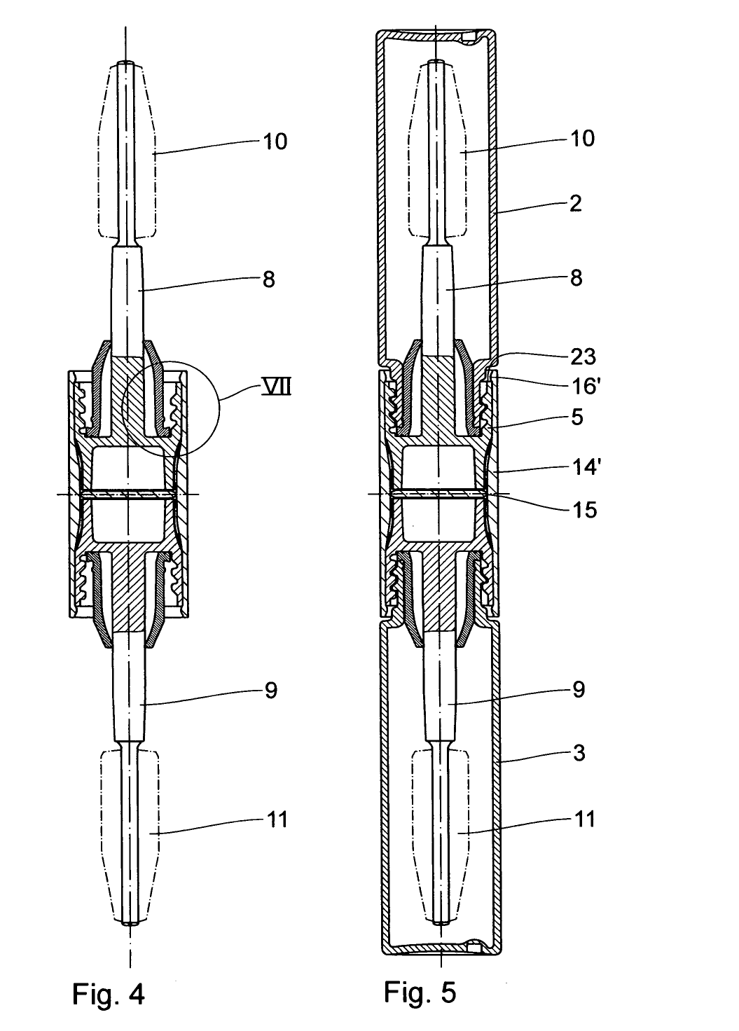

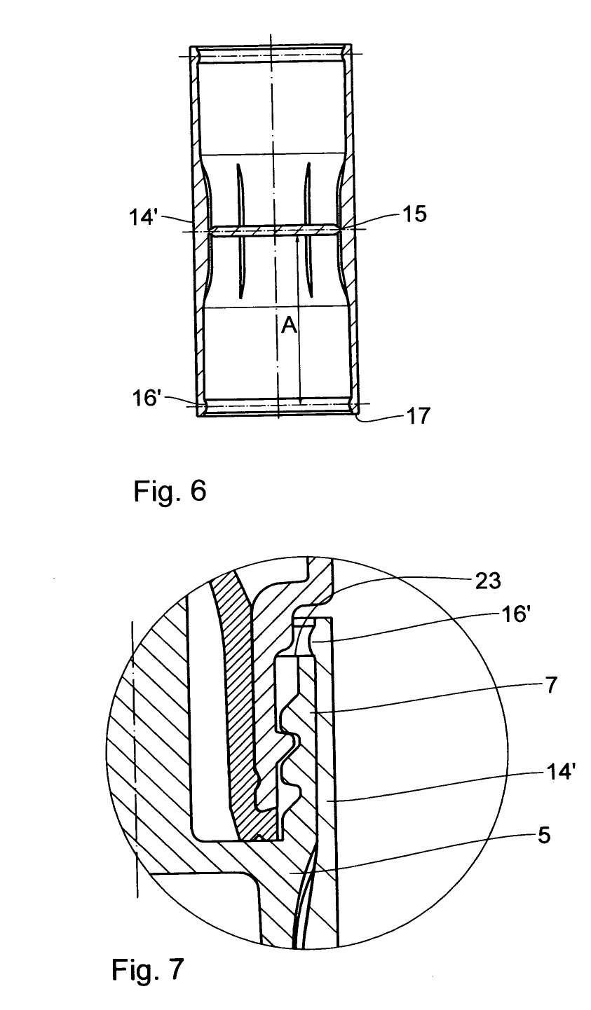

The embodiment depicted in FIGS. 4 through 6 has the same basic structure as the embodiment according to FIG. 1 through 3, so that, in this context, reference can be made to the above description.

Only the coupling sleeve 14′ has been modified from the above-described embodiment in such a way that the locking bead 16′ is formed directly at the front end 17, and the distance A between the top surface of the dividing bottom 15 and apex region of the locking bead 16′ is dimensioned such that when a coupling part 4, 5 snaps in, it moves to an end stop against the dividing bottom 15 on one hand, and the locking bead 16′ simultaneously snaps in over the front end 23 of the coupling part 4, 5, i.e., a separate locking groove 18 on the respective coupling part 4, 5 is not required in the case of this embodiment.

What is claimed is:

1. A cosmetic unit comprising two applicators, each having a stem, each of the applicators dipping into a respective reservoir, each reservoir (2, 3) having a reservoir neck (12) provided with an external thread (13) on which to screw a respective coupling part (4, 5), and the two reservoirs (2, 3) being releasably attachable to each other by means of the screwed-on coupling parts, which at the same time serve as a closing cap, via a coupling sleeve (14′) by means of a snap-type connection, wherein the snap-type connection comprises a locking bead (16, 16′) disposed on the inside of the coupling sleeve (14, 14′) in the outer end region of the coupling sleeve (14, 14′).

2. A cosmetic unit according to claim 1, wherein the locking bead (16, 16′) is disposed less than 5 mm from the respective front end (17) of the coupling sleeve (14, 14′).

3. A cosmetic unit according to claim 1, wherein the locking bead (16, 16′) in the engaged condition overlaps the respective front end (17) of the coupling part (4, 5).

4. A cosmetic unit according to claim 1, wherein the locking bead (16) cooperates with a corresponding locking groove (18) of the respective coupling part (4, 5).

5. A cosmetic unit according to claim 4, wherein the locking bead (19) has an end region (21) that is beveled in the insertion and snap-in direction (arrow 20).

6. A cosmetic unit according to claim 4, wherein the locking bead (19) has, against the insertion direction (arrow 20), a section (22) extending by approximately 90° against the longitudinal axis of the coupling sleeve (14).

7. A cosmetic unit according to claim 1, wherein the coupling part (4, 5) has a thread whose pitch is between 1.0 and 8 mm.

8. A cosmetic unit according to claim 1, wherein the coupling part (4, 5) has a stem 8 having a diameter between 1.5 and 15.0 mm.
